(19) United States
(12) Patent Application Publication
(10) Pub. No.: US 2016/0145771 A1
(43) Pub. Date: May 26, 2016

(54) NANO-FIBER SPINNING APPARATUS USING CENTRIFUGAL FORCE AND METHOD OF MANUFACTURING NANO-FIBER USING THE SAME

(71) Applicants: Woori nano co., Jeonju-si (KR); INDUSTRIAL COOPERATION FOUNDATION CHONBUK NATIONAL UNIVERSITY, Jeonju-si (KR)

(72) Inventors: Hak-Yong KIM, Jeonju-si (KR); Tae-Hwan HAN, Seoul (KR); Tae-Woo KIM, Jeonju-si (KR); Baek-Ho LIM, Jeonju-si (KR); Tae-Hee AN, Chungju-si (KR); Jong-Wan KIM, Namwon-si (KR); Su-Hyeong CHAE, Jeonju-si (KR)

(73) Assignees: Woori nano co., Jeonju-si (KR); INDUSTRIAL COOPERATION FOUNDATION CHONBUK NATIONAL UNIVERSITY, Jeonju-si (KR)

(21) Appl. No.: 14/638,500

(22) Filed: Mar. 4, 2015

(30) Foreign Application Priority Data
Nov. 20, 2014 (KR) 10-2014-0162364

(51) Int. Cl. D01D 5/18; B04B 5/00

(52) U.S. Cl. CPC D01D 5/18; B04B 5/00

(57) ABSTRACT

Disclosed is a nano-fiber spinning apparatus using centrifugal force which includes: (i) a top plate 6c which has nano-fiber spinning holes h, and is slantly formed at an inclination angle α with a virtual horizontal line connecting top of a side wall 6b in a disk shape; (ii) a bottom plate 6a having a curved surface which is concaved and inclined upwardly in a dish shape; and (iii) the cylindrical side wall 6b connecting the top plate 6c and the bottom plate 6a, so as to be wholly formed in a spin-top shape. Also, disclosed is a method of manufacturing nano-fibers which includes, after supplying a spinning dope to the above nano-fiber spinning apparatus 6, spinning nano-fibers with centrifugal force toward a collector 7 provided above the apparatus while generating an air flow toward the collector by an air generator provided below the nano-fiber spinning apparatus 6.

### RELATED APPLICATIONS

This application claims priority to Korean Patent Application No. 10-2014-0162364, filed on Nov. 20, 2014 in the Korean Intellectual Property Office, the entire disclosure of which is incorporated herein by reference.

### BACKGROUND OF THE INVENTION

1. Field of the Invention

The present invention relates to a nano-fiber spinning apparatus using centrifugal force and a method of manufacturing nano-fibers using the same, and more specifically, to a method of manufacturing nano-fibers only using centrifugal force and air flow, which can achieve high production per unit hour without occurrence of a phenomenon that a spinning dope drips in a liquid state (hereinafter referred to as a “drop generation phenomenon”) even though electrostatic power is not applied, as well as a nano-fiber spinning apparatus used for the above method.

2. Description of the Related Art

In general, nano-fibers have been prepared by using an electronic spinning (‘electro-spinning’) method. Among conventional electro-spinning apparatuses used for preparing the nano-fibers, a fixed nozzle has mostly been employed as a discharging device of a spinning dope, as disclosed in Korean Patent Registration No. 10-0420460.

However, since the conventional electro-spinning apparatuses as described above electrically spin (discharge) the spinning dope through the fixed nozzle, electro-spinning has been executed by electrostatic power alone and thus a discharge rate per unit hole of the nozzle per unit hour was very low in a level of 0.01 g to decrease productivity. Consequently, problems such as difficulties in mass production, highly complex and complicate replacement and cleaning of nozzles, or the like, have been entailed.

In general, a production rate of nano-fibers through electro-spinning is in a level of about 0.1 to 1 g per hour, and the solution discharging rate is also very low in a level of about 1.0 to 5.0 mL per hour [D. H. H. Renecker et al., Nanptechnology 2006, Vol. 17, 1123].

Another conventional electro-spinning apparatus is an electro-spinning apparatus that executes electro-spinning using electrostatic power and centrifugal force, simultaneously, and by supplying a polyvinyl pyrrolidone solution to a conical vessel rotating at 50 rpm while applying high voltages thereto, without any nozzle, which has been described in an article disclosed in the bulletin, Small 2010, by Jinyuan Zhou et al. of Nanzhou University (Small, 2010 Vol. 6, 1612-1616).

However, although the above electro-spinning apparatus may utilize centrifugal force and electrostatic power to improve the production rate per unit hour even without any nozzle, it entailed such problems that the spinning dope is continuously fed into a conical vessel to cause a difficulty in continuous production, a collector is located below the conical vessel to occur a phenomenon of dripping the spinning dope in a liquid state (‘drop generation phenomenon’) other than a fiber form, and the like.

Further, an alternative electro-spinning system mode provided with a plurality of nozzles arranged on a nozzle panel has also been well known [H. Y. Kim, WO 2005 073441, WO 2007 035011].

The above-described electro-spinning system mode embraces very low production rate of nano-fibers per unit hole and using nozzles to cause a problem of troublesome cleaning.

FIG. 4 illustrates a conventional process of preparing candy fibers using sugar, which has been well known in viewpoint of history. Production of fibers based on such a conventional method as described above is a method of efficiently preparing nano-fibers only using mere centrifugal force.

A mechanism for formation of nano-fibers through holes of a rotating cylindrical vessel is generally similar to a mechanism for formation of threads by a rotor in open-end method in a cotton spun process, and Parker et al. of Harvard University discloses a method of manufacturing nano-fibers which includes collection of nano-fibers formed through holes of a rotating cylindrical vessel in a cylindrical collector mounted on an outer periphery thereof, through an article published in 2010 [Nanoletters, 10, 2257-2261, 2010].

Further, U.S. Pat. No. 8,231,378 B2 discloses a superfine fiber creating spinneret in which centrifugal force acts in a circumferential direction by arranging holes around the circumference of a cylindrical vessel to thus scatter micro- or nano-fibers in the circumferential direction and collect the same in a collector mounted in the circumferential direction. Further, heat may be applied thereto.

However, the above-described conventional methods cannot collect nano-fibers upwardly to hence have a difficulty in production of a nano-fiber web, and encounter a problem of deteriorated solvent volatility.

### SUMMARY OF THE INVENTION

In consideration of the above-described circumstances, it is an object of the present invention to provide a method of manufacturing nano-fibers with desired efficiency, only using centrifugal force and air flow even without application of electrostatic power, which exhibits high production rate per unit hour but does not occur a phenomenon of dripping a spinning dope in a liquid state (hereinafter, referred to as ‘drop generation phenomenon’).

Another object of the present invention is to provide a nano-fiber spinning apparatus using centrifugal force, which is used in the above method.

In order to accomplish the above objects, there is provided a nano-fiber spinning apparatus, including: (i) a top plate which has nano-fiber spinning holes, and is slantly formed at an inclination angle decreasing from outer peripheral edges to a center with respect to a virtual horizontal line connecting the outer peripheral edges of a cylindrical side wall so as to have a disk shape; (ii) a bottom plate having a curved surface which is concaved and inclined upwardly so as to have a dish shape; and (iii) the cylindrical side wall which connects the top plate and the bottom plate, so as to be wholly formed in a spin-top shape. After supplying a spinning dope to the nano-fiber spinning apparatus, the nano-fibers are spun toward a collector placed on a top site using centrifugal force while generating an air flow toward the collector from an air generator located below the nano-fiber spinning apparatus.

The present invention may only use centrifugal force and air flow without application of electrostatic power, and spin nano-fibers without using conventional spinning nozzle, therefore, can attain some advantages of, in particular: avoiding danger in working due to application of high voltages; preparing nano-fibers with high productivity (discharge rate); overcoming troubles in nozzle replacement and cleaning thereof; easily volatilizing and recovering a solvent; and efficiently preventing a phenomenon of dripping a spinning dope in a liquid state (‘drop generation phenomenon’) on the collector other than a fiber form, thereby improving quality of nano-fiber webs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a process of manufacturing a nano-fiber web according to the present invention;

FIG. 2 is a schematic cross-sectional view illustrating a nano-fiber spinning apparatus 6 according to the present invention;

FIG. 3 is a perspective view illustrating a state of spinning nano-fibers by the nano-fiber spinning apparatus 6 according to the present invention;

FIG. 4 is a photograph showing a conventional process of manufacturing sugar fibers;

FIGS. 5 and 6 are electro-micrographs showing the nano-fiber web manufactured according to Example 1; and

FIGS. 7 and 8 are electro-micrographs showing the nano-fiber web manufactured according to Example 2.

### DETAILED DESCRIPTION OF THE INVENTION

Hereinafter, preferred embodiments of the present invention will be described in detail with reference to the accompanying drawings.

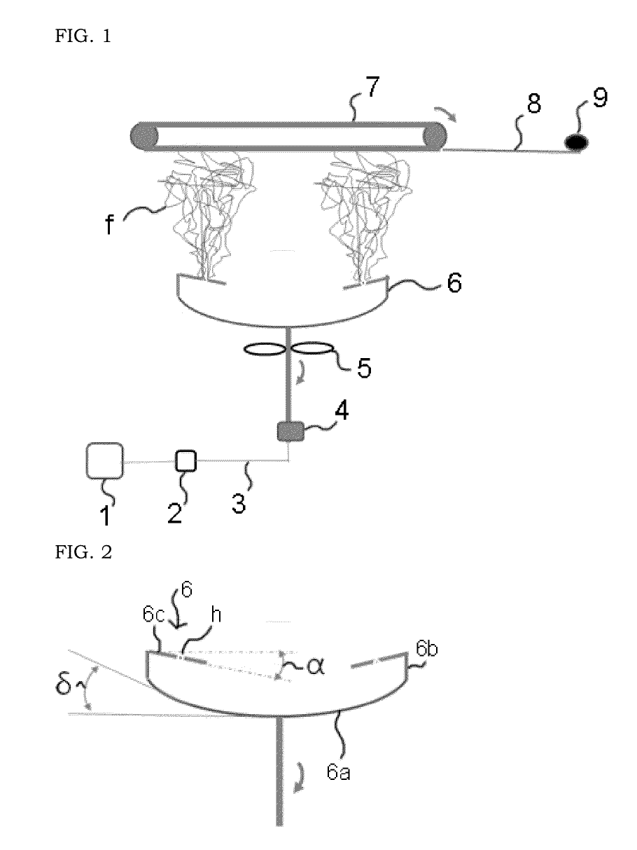

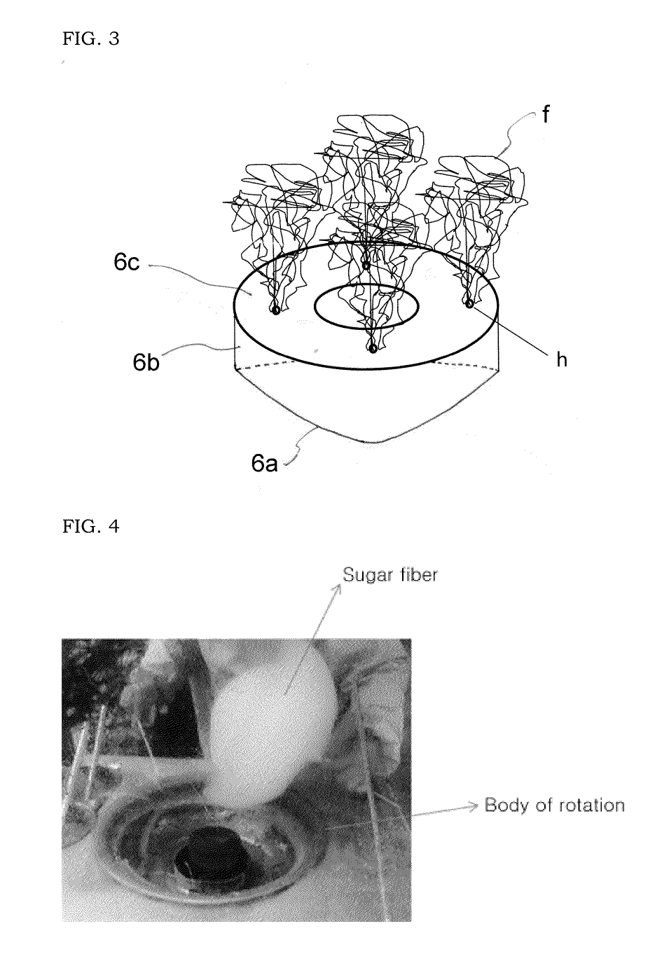

As illustrated in FIGS. 1 to 3, the nano-fiber spinning apparatus 6 using centrifugal force according to the present invention includes: (i) a top plate 6c which has nano-fiber spinning holes h, and is slantly formed at an inclination angle α decreasing from outer peripheral edges to a center with respect to a virtual horizontal line connecting the outer peripheral edges of a cylindrical side wall 6b so as to have a disk shape; (ii) a bottom plate 6a having a curved surface which is concaved and inclined upwardly so as to have a dish shape; and (iii) the cylindrical side wall 6b which connects the top plate 6c and the bottom plate 6a, so that the apparatus 6 is wholly formed in a spin-top shape.

The bottom plate 6a, the side wall 6b and the top plate 6c included in the nano-fiber spinning apparatus 6 may be integrally formed, or only the bottom plate 6a and the side wall 6b may be integrally formed, while the top plate 6c is separately prepared, then, coupled to the outer peripheral edges of the side wall 6b in a subsequent process.

The inclination angle α between the top plate 6c and the virtual horizontal line connecting the outer peripheral edges of the side wall 6b may range from 1 to 70°, and preferably, 1 to 45°.

An inclination angle δ between the curved surface forming the bottom plate 6a and another virtual horizontal line passing through the lowest point of the bottom plate 6a may range from 1 to 70°.

According to the present invention, since the top plate 6c is slantly formed at the inclination angle α and the bottom plate 6a is also slantly formed at the inclination angle δ which is substantially the same as the inclination angle α, a spinning dope may be stably fed into the nano-fiber spinning holes h formed in the top plate 6c of the nano-fiber spinning apparatus 6, and thus make it easy to spin nano-fibers toward the collector 7 provided above the apparatus without a drop generation phenomenon.

The number of the nano-fiber spinning holes h formed in the top plate 5c may be at least one, and the hole may have a cross-section formed in a circular form, modified form such as triangular, rectangular, slit or elliptical form, or a protruded pin form.

The nano-fiber holes h formed in the top plate 6c having a disk shape in a plan view are preferably arranged in a circumferential direction or diagonal direction of the top plate 6c.

Meanwhile, as illustrated in FIG. 1, a method of manufacturing nano-fibers according to the present invention includes: supplying a spinning dope formed of at least one selected from a polymer solution and a polymer molten material to the nano-fiber spinning apparatus, including: (i) a top plate 6c which has nano-fiber spinning holes h, and is slantly formed at an inclination angle α decreasing from outer peripheral edges to a center with respect to a virtual horizontal line connecting the outer peripheral edges of a cylindrical side wall 6b so as to have a disk shape; (ii) a bottom plate 6a having a curved surface which is concaved and inclined upwardly so as to have a dish shape; and (iii) the cylindrical side wall 6b which connects the top plate 6c and the bottom plate 6a, so that the apparatus 6 is wholly formed in a spin-top shape, and the bottom plate 6a is connected to a motor 4 by a connection bar; rotating the nano-fiber spinning apparatus 6 by driving the motor 4 to generate centrifugal force, which in turn, spins the spinning dope fed into the nano-fiber spinning apparatus 6 through the nano-fiber spinning holes h toward a collector 7 provided above the nano-fiber spinning apparatus 6, in a form of nano-fiber f; and generating an air flow upwardly of the nano-fiber spinning apparatus 6 by an air generator provided below the nano-fiber spinning apparatus 6, so as to collect the nano-fibers f spun through the nano-fiber spinning holes h into the collector 7.

Specifically, as illustrated in FIG. 1, the present invention may supply a spinning dope stored in a spinning dope supply vessel 1 to the nano-fiber spinning apparatus 6 having the bottom plate 6a connected to the motor 4 by the connection bar, through a metering pump 2 which connected to the motor through a spinning dope supply duct 3.

Next, rotating the nano-fiber spinning apparatus 6 using the motor 4 connected to a lower end thereof generates centrifugal force, which may be used to spin the spinning dope fed into the nano-fiber spinning apparatus 6 through the nano-fiber spinning holes h toward the collector 7 provided above the nano-fiber spinning apparatus 6 in a nano-fiber form f. At the same time, an air flow is generated in a direction of the collector 7 by the air generator provided below the nano-fiber spinning apparatus 6 to collect spun nano-fibers f in the collector 7. Thereafter, the collected nano-fibers f may be separated and formed into a nano-fiber web 8, followed by winding the web.

An example of the air generator may be a rotating fan 5 fixed to the connection bar for connecting the motor 4 and the nano-fiber spinning apparatus 6.

The present invention only uses the centrifugal force and air flow without application of electrostatic power and spins nano-fibers without using conventional spinning nozzles, therefore, may attain beneficial features, including: avoiding danger in working due to application of high voltages to a collector or the like; preparing nano-fibers with high productivity (discharge rate); overcoming troubles in replacement and cleaning of nozzles; easily volatilizing and recovering a solvent; and efficiently preventing a phenomenon of dripping a spinning dope in a liquid state (‘drop generation phenomenon’) on the collector other than a fiber form, thereby improving quality of nano-fiber webs.

Hereinafter, examples of the present invention will be described in more details.

However, it will be apparent to those skilled in the art that such examples are provided for illustrative purposes without limitation of the present invention

### Example 1

Polyvinylalcohol having a weight average molecular weight Mw of 80,000 was dissolved in water as a solvent to prepare a spinning dope with a solid content of 30 wt. % and a viscosity of 8,500 cps.

Next, as illustrated in FIG. 1, the prepared spinning dope was fed into a nano-fiber spinning apparatus 6 at a feeding rate of 2 cc/min per each metering pump, wherein the apparatus 6 includes: (i) a top plate 6c which has nano-fiber spinning holes h, and is slantly formed at an inclination angle α decreasing from outer peripheral edges to a center with respect to a virtual horizontal line connecting the outer peripheral edges of a cylindrical side wall 6b so as to have a disk shape; (ii) a bottom plate 6a having a curved surface which is concaved and inclined upwardly so as to have a dish shape; and (iii) the cylindrical side wall 6b which connects the top plate 6c and the bottom plate 6a, so that the apparatus 6 has a spin-top form in overall viewpoint. Then, centrifugal force was generated by rotating the nano-fiber spinning apparatus 6 at 4,500 rpm. The centrifugal force was used to spin the spinning dope fed into the nano-fiber spinning apparatus 6 through the nano-fiber spinning holes h toward a collector 7, which is provided above the apparatus 6 and rotates at a speed of 0.1 m/min, in a form of nano-fiber f. At the same time, the centrifugal force rotated a fan 5 provided at the lower end of the nano-fiber spinning apparatus 6 to generate an air flow upwardly.

In this regard, a maximum diameter of the nano-fiber spinning apparatus 6 was 80 mm, an inclination angle α between the top plate 6c and the virtual horizontal line was 20°, and an inclination angle δ between another virtual horizontal line and a curved surface forming the bottom plate 6a was 15°.

Further, each of the nano-fiber spinning holes h had a diameter of 0.8 mm and a length of 10 mm, and the number of the nano-fiber spinning holes h was 4.

Next, a nano-fiber web 8 was prepared using nano-fibers collected in the collector 7, then, wound.

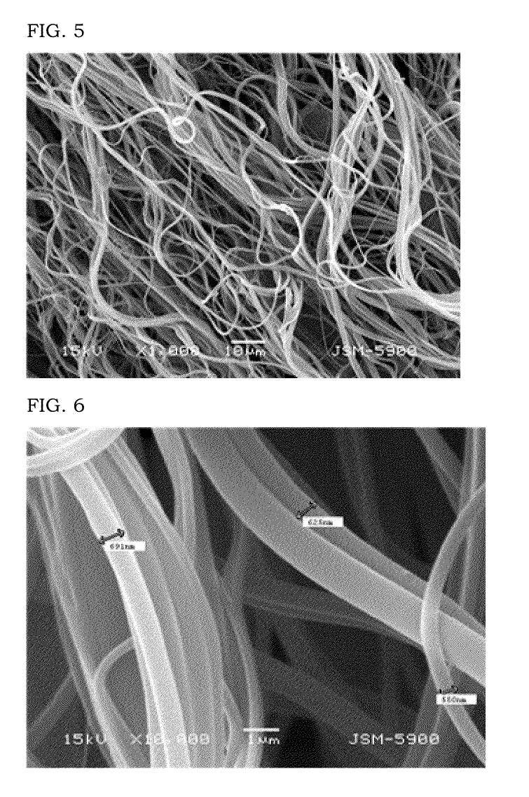

The formed nano-fiber web was shown in electro-micrographs of FIGS. 5 and 6. FIG. 6 is an enlarged electro-micrograph of FIG. 5 with a magnification of 10 times.

The nano-fibers included in the prepared nano-fiber web had an average diameter of 620 nm.

### Example 2

Polyvinylalcohol having a weight average molecular weight Mw of 80,000 was dissolved in water as a solvent, to prepare a spinning dope with a solid content of 25 wt. % and a viscosity of 7,000 cps.

Next, as illustrated in FIG. 1, the prepared spinning dope was fed into a nano-fiber spinning apparatus 6 at a feeding rate of 2 cc/min per each metering pump, wherein the apparatus 6 includes: (i) a top plate 6c which has nano-fiber spinning holes h, and is slantly formed at an inclination angle decreasing from outer peripheral edges to a center with respect to a virtual horizontal line connecting the outer peripheral edges of a cylindrical side wall 6b so as to have a disk shape; (ii) a bottom plate 6a having a curved surface which is concaved and inclined upwardly so as to have a dish shape; and (iii) the cylindrical side wall 6b which connects the top plate 6c and the bottom plate 6a, so that the apparatus 6 has a spin-top form in overall viewpoint. Then, centrifugal force was generated by rotating the nano-fiber spinning apparatus 6 at 4,500 rpm. The centrifugal force was used to spin the spinning dope fed into the nano-fiber spinning apparatus 6 through the nano-fiber spinning holes h toward a collector 7, which is provided above the apparatus 6 and rotates at a speed of 0.1 m/min, in a form of nano-fiber f. At the same time, the centrifugal force rotated a fan 5 provided at the lower end of the nano-fiber spinning apparatus 6 to generate an air flow upwardly.

In this regard, a maximum diameter of the nano-fiber spinning apparatus was 80 mm, an inclination angle α between the top plate 6c and the virtual horizontal line was 20°, and an inclination angle δ between another virtual horizontal line and a curved surface forming the bottom plate 6a was 15°.

Further, each of the nano-fiber spinning holes h had a diameter of 0.8 mm and a length of 10 mm, and the number of the nano-fiber spinning holes h was 4.

Next, a nano-fiber web 8 was prepared using nano-fibers collected in the collector 7, then, wound.

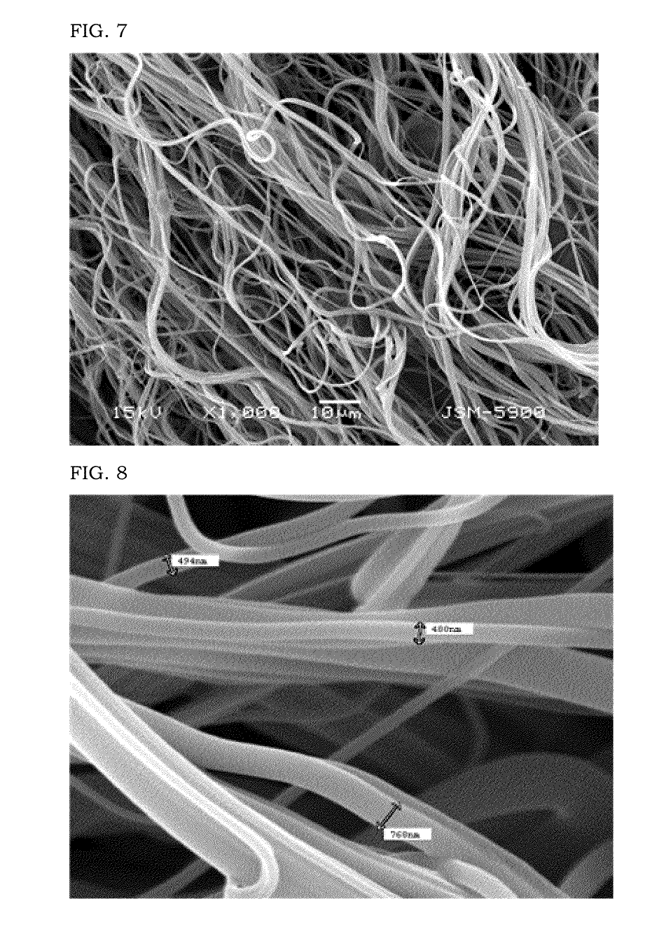

The formed nano-fiber web was shown in electro-micrographs of FIGS. 7 and 8. FIG. 8 is an enlarged electro-micrograph of FIG. 7 with a magnification of 10 times.

The nano-fibers included in the prepared nano-fiber web had an average diameter of 580 nm.

As described above, since nano-fiber spinning apparatus according to the present invention only uses the centrifugal force and air flow without application of electrostatic power and spins nano-fibers without using conventional spinning nozzles, it may accomplish some advantages, including: avoiding danger in working due to application of high voltages to a collector or the like; preparing nano-fibers with high productivity (discharge rate); overcoming troubles in replacement and cleaning of nozzles; easily volatilizing and recovering a solvent; and efficiently preventing a phenomenon of dripping a spinning dope in a liquid state (‘drop generation phenomenon’) on the collector other than a fiber form, thereby improving quality of nano-fiber webs.

While the present invention has been described with reference to the preferred embodiments, it will be understood by those skilled in the related art that various modifications and variations may be made therein without departing from the scope of the present invention as defined by the appended claims.

What is claimed is:

1. A nano-fiber spinning apparatus using centrifugal force, comprising:
(i) a top plate which has nano-fiber spinning holes, and is slantly formed at an inclination angle decreasing from outer peripheral edges to a center with respect to a virtual horizontal line connecting the outer peripheral edges of a cylindrical side wall so as to have a disk shape;
(ii) a bottom plate having a curved surface which is concaved and inclined upwardly so as to have a dish shape; and
(iii) the cylindrical side wall which connects the top plate and the bottom plate, so as to be wholly formed in a spin-top shape.

2. The apparatus according to claim 1, wherein the bottom plate and the side wall are integrally formed, and the top plate is separately prepared then coupled to the outer peripheral edges of the side wall 6b.

3. The apparatus according to claim 1, wherein the inclination angle between the top plate and the virtual horizontal line connecting the outer peripheral edges of the side wall ranges from 1 to 70°.

4. The apparatus according to claim 1, whereat an inclination angle between the curved surface forming the bottom plate and another virtual horizontal line passing through the lowest point of the bottom plate ranges from 1 to 70°.

5. The apparatus according to claim 1, wherein each nano-fiber spinning hole formed in the top plate 6c has a cross-section formed in a shape of at least one selected from triangular, rectangular, slit, circular and elliptical forms, or a protruded pin form.

6. The apparatus according to claim 1, wherein the nano-fiber spinning holes formed in the top plate are arranged in at least one direction selected from a circumferential direction and a diagonal direction of the top plate.

7. A method of manufacturing nano-fibers using centrifugal force and an air flow, comprising:
supplying a spinning dope formed of at least one selected from a polymer solution and a polymer molten material to a nano-fiber spinning apparatus, including: (i) a top plate which has nano-fiber spinning holes, and is slantly formed at an inclination angle decreasing from outer peripheral edges to a center with respect to a virtual horizontal line connecting the outer peripheral edges of a cylindrical side wall so as to have a disk shape; (ii) a bottom plate having a curved surface which is concaved and inclined upwardly so as to have a dish shape; and (iii) the cylindrical side wall which connects the top plate and the bottom plate, so as to be wholly formed in a spin-top shape, and the bottom plate is connected to a motor by a connection bar;
rotating the nano-fiber spinning apparatus by driving the motor to generate centrifugal force, which in turn, spins the spinning dope fed into the nano-fiber spinning apparatus through the nano-fiber spinning holes toward a collector provided above the nano-fiber spinning apparatus, in a form of nano-fiber; and
generating an air flow upwardly of the nano-fiber spinning apparatus by an air generator provided below the nano-fiber spinning apparatus, so as to collect the nano-fibers spun through the nano-fiber spinning holes into the collector.

8. The method according to claim 7, wherein the air generator includes a fan fixed to the connection bar which connects the motor and the nano-fiber spinning apparatus.
